(19) United States
(12) Patent Application Publication
(10) Pub. No.: US 2011/0117338 A1
(43) Pub. Date: May 19, 2011

(54) OPEN PORE CERAMIC MATRIX COATED WITH METAL OR METAL ALLOYS AND METHODS OF MAKING SAME

(76) Inventors: Ben Poquette, Wauwatosa, WI (US); Jennifer Mueller, Bristol, TN (US); Michael Asaro, Flagstaff, AZ (US); Patrick Dykema, Arlington, VA (US); Stephen Kampe, Hancock, MI (US); Gary Pickrell, Blacksburg, VA (US)

(21) Appl. No.: 12/933,628

(22) PCT Filed: Apr. 28, 2009
(86) PCT No.: PCT/US2009/041864

§ 371 Date: Dec. 20, 2010

Related U.S. Application Data
(60) Provisional application No. 61/125,841, filed on Apr. 29, 2008.

(51) Int. Cl. B32B 7/02; B05D 5/00

(52) U.S. Cl. 428/213; 427/244

(57) ABSTRACT

Open pore foams are coated with metal or metal alloys by electrolytic or electroless plating. The characteristics of the plating bath are adjusted to decrease the surface tension such that the plate bath composition can pass into the pores of the foam, preferably at least two and most preferably more than five pores in depth from the surface of the foam matrix. This can be accomplished by adding a surfactant, solvent or other constituent to reduce the surface tension of the plate bath. In addition, heat and pressure can be used to drive in the plate bath composition into the passage ways of connected open pores in the foam matrix. The net result is to plate the inside surfaces of the pores in the foam matrix, while maintaining the passageways through the foam. Pretreatment of the pore surfaces can be used to promote adhesion of the metal. Particularly advantageous results are achieved when the foam matrix is a ceramic foam.

### CROSS-REFERENCE TO RELATED APPLICATIONS

This application claims priority to U.S. Provisional Patent Application 61/125,841 filed Apr. 29, 2008, and the complete contents of that application are fully incorporated herein by reference.

### BACKGROUND OF THE INVENTION

1. Field of the Invention

The invention generally relates to materials, and more particularly, to foam matrices having an open pore structure where a metal or metal alloy coats the pores within the foam matrix. The invention is also generally related to electrolytic and electroless plating of foam matrices.

2. Background of the Invention

Few references describe methods for applying metal coatings to foam matrices, and particularly ceramic foam matrices. U.S. Pat. No. 5,503,941 to Pruyn and U.S. Pat. No. 5,584,983 to Pruyn describe a metal foam. In the Pruyn process the starting material being plated is used only as a scaffold, and is then melted away. U.S. Pat. No. 6,395,402 to Lambert describes an electrically conductive polymeric foam. Wiechman et al., “High Thermal Conductivity Graphite Foam-Progress and Opportunities”, Proceeding of the International Society for the Advancement of Materials and Process Engineering (SAMPE) Technical Conference, Dayton Ohio, 9 Sep. 2003, indicates that companies have been investigating plating metals on the surface of carbon foams by electrodeposition or electroless plating so that the graphite foam is coated prior to soldering.

A particular problem with coating foam matrices is the ability to coat the pores inside the foam. In prior art methods, the coating material is plated onto the top or bottom surface of a foam and does not penetrate into the foam and may also plug the passages of the foam at the surface. Ideally, penetration throughout the foam's interior will allow the foam to obtain the benefits of both the foam matrix and the metal plating. Further, conformal coating of the pores within the foam will allow the foam to have the same attributes of the foam matrices in terms of flow through passage and increased surface area; however, such devices and systems have not been heretofore realized.

### SUMMARY OF THE INVENTION

According to the invention, methods have been devised to, preferably fully and uniformly, coat the surfaces of open pores throughout the thickness of foam materials with metal in a way that does not close the porosity and leaves fluid flow though the foams unhindered. Plating the foam matrix can be performed by electrochemical techniques, such as electroless or electrolytic deposition. Particularly promising results are obtained when utilizing a plating bath having a low surface tension. The baths can be controlled to vary the thickness of the metal coating, and can be used to plate electrically conductive or non-conductive foams. The combination of the large surface area of the foams and the numerous metals and alloys that can be deposited with this method results in a final composite with a broad range of applications in areas such as: improved solderability and thermal management (heat sinks, heat exchangers, phase-change cooling systems, thermally conducting structures); catalysis (catalytic converters, fuel cells, hydrogenation); electromagnetic interference (EMI) shielding, and acoustic dampening (gun silencers). The coatings lend properties to the foam matrix which stem from the deposited metal, such as increased strength; toughness; ferromagnetism; corrosion resistance; etc., to any application of the foams.

Ceramic matrix composite (CMC) systems according to the invention may include a matrix of carbon or graphite with a deposited layer of copper or nickel. Additional plating materials include but are not limited to palladium, platinum, silver, copper, nickel, tin, titanium, aluminum, their oxides, tungsten carbide, silicon carbide, chromium carbide, and combinations thereof for plating by either electroless or electrolytic means. Using this method, nearly any foamable material could be uniformly coated. The metal coated foams have a lower pressure drop for air flow across the width of the foam compared to unplated foam, suggesting that the metal coating assists in producing more laminar flow.

The surface tension of the plating bath can be adjusted directly by adding surfactants, solvents or other additives to the plating bath. In addition, these agents (surfactants, solvents and other additives which reduce surface tension) can be added indirectly by being carried in by fixturing and other hardware or by the foam itself. The surface tension may be reduced by heating the plating bath. In addition, the surface tension may be overcome by applying hydraulic pressure at the time the metal or metal alloy is plated on the pore surfaces of the foam. Also, combinations of surfactants, solvents, heat adjustment, and pressure adjustment can be used to assure deep penetration of the plating bath constituents in the foam material and possible plating throughout the width of the foam material.

### BRIEF DESCRIPTION OF THE DRAWINGS

FIG. 1 is a schematic diagram of a foam matrix where open pores throughout the thickness dimension can be coated with a metal or metal alloy by electrolytic or electroless plating;

FIG. 2 is a scanning electron micrograph off a graphite foam with open pores coated with copper;

FIG. 3 is a schematic diagram of a particle uses for colloidal catalysis, as an alternative to sensitization and activation catalysis;

FIG. 4 shows a cross-sectional view of a copper coating throughout the thickness of a graphite foam; and

FIG. 5 is a schematic drawing of a typical electrodeposition cell.

### DETAILED DESCRIPTION

The cohesive force between liquid molecules is responsible for the phenomenon known as surface tension. Specifically, molecules at the surface of a liquid do not have other like molecules on all sides, and consequently the cohere more strongly to other like molecules directly associated with them on the surface. Surface tension prevents coating materials from penetrating deep within foam matrices.

By decreasing the surface tension of metal or metal alloy plating baths, it has been found that open pore ceramic foams (i.e., ceramic foams having pores of 10 nm-100 mm in diameter, and particularly ceramic foams having pores of 1 mm or smaller) can be effectively coated with a conformal metal or metal alloy coating which adheres to the surfaces of the pores inside the ceramic foams. The surface tension can be decreased, preferably by 25% or more and more preferably by 35% or 50% or more, by the addition of surfactants, solvents, or other constituents which decrease surface tension to plating bath compositions. It is advantageous if the plating bath composition has a surface tension of 50 dynes/cm or lower, and more preferably 40 dynes/cm or 30 dynes/cm or lower. However, benefits for applying a metal or metal alloy coating to the open pores of ceramic matrix foams can be achieved simply by reducing the plating bath surface tension by 15-20 dynes/cm or more. The additives which can accomplish the requisite reduction in surface tension of a plating bath include, but are not limited to, cationic, anionic, zwitterionic, nonionic surfactants, and fluorosurfactants such as “Zonyl” and “Triton”, including ordinary soaps such as “Ivory” and “Dawn”, shampoos such as “Suave” and “Pantene”, detergents such as “Tide” and “Borax”, fabric softener such as “Downy” and “Snuggle”, foaming agents such as sodium lauryl sulfate and ammonium lauryl sulfate, dispersants such as “NanoSperse AQ” and “Versatex”, plasticizers such as “Jayflex” and “K-FLEX”, emulsifiers such as gum arabic and cetostearyl alcohol, as well as other common chemicals which can be used to decrease the surface tension of water, including residues that may be left on hardware after cleaning, as well as combinations of any of the above constituents. In the practice of the invention, reduction in surface tension by the addition of one or more constituents which lower the surface tension of the coating bath relative to the coating bath in the absence of the constituents will promote coating infiltration into the foam. The base surface tension of water is 72 dyn/cm in air. Most alcohols exhibit surface tensions in the low twenties. Good results have been achieved when the bath is generally below 35 dyn/cm, which can be accomplished with the addition of surfactants. As a general rule of thumb, a surface tension of under 50 dyn/cm corresponds to an approximate ˜30% reduction in surface tension, and a surface tension under 35 dyn/cm corresponds to an approximate ˜50% reduction in surface tension

The surface tension altering constituents can be added directly to the bath (as discussed above. However, it should be understood that these constituents may also be carried in by fixturing and other hardware or by the foam itself. Fixturing and hardware would be anything that come into contact with the plating bath during the plating process (e.g., racks or baskets holding the foam; tubing or containers which hold or transport other bath constituents; etc.). Thus, it will be recognized that the plating bath can be altered so as to have a reduced surface tension by combining surface tension altering constituents to the fixturing or hardware used in the process. Furthermore, surface altering constituents might also be carried by the foam itself. For example, a piece of foam could be dipped in or spray coated with a surfactant prior to adding the foam to a plating bath. Alternatively, the foam could be pre-cleaned in a bath containing an excessive amount of surfactant, and then be added to the plating bath without a rinse in pure water in between so that there would be carryover of surfactant to the plating bath (this may work well with strong surfactants).

In addition, surface tension can be overcome by the application of hydraulic pressure to force plating batch compositions through the open pores of a ceramic matrix foam having pores of 10 nm to 100 mm in diameter. Hydraulic pressure which is applied should be sufficient to reduce the surface tension and advance plating bath composition through the tortuous pathways of open pores in the ceramic foam, but should not be strong enough to crush or compact the ceramic matrix foam, i.e., hydraulic pressures ranging from zero up to the fracture strength of the base foam would be suitable. For example, with ceramic matrix foams, suitable hydraulic pressure can have a force of 0.001 to 32,633 ksi, and particularly 0.01-100 ksi. Suitable mechanism for applying hydraulic pressure include the application and removal of a vacuum, pumping of the plating bath solution with or without jetted nozzles, and agitation or movement of the foam within the solution. In the practice of the invention, hydraulic pressure can be used alone or in combination with the use of temperature or the addition of surfactants, solvents or other constituents to lower the surface tension of the plating bath composition.

Also, surface tension can be overcome by the application of heat to the plating bath composition. The heat applied should elevate the temperature of the plating bath composition above the freezing point of the constituents to a point which is less than the boiling point of the base solvent of the plating bath composition. For example, in an aqueous plating bath containing metal salts as precursors, increasing the temperature to 50-90° C. may provide a reduction in surface tension sufficient to allow penetration of the plating bath composition through the open pores of a ceramic foam. In the practice of the invention, temperature elevation can be used alone or in combination with the use of hydraulic pressure or the addition of surfactants, solvents or other constituents to lower the surface tension of the plating bath composition.

The invention has particular application to ceramic matrix foams. For example, the foam matrix can be an open pore foam of graphite, titania, alumina, silicon carbide, or any other ceramic material, including oxides, carbides, borides, nitrides, silicides and glasses, which would benefit from having open pores coated with a metal or metal alloy. However, aspects of the invention might also be practiced with other foam matrices including, for example, polymer and metal foams. Exemplary foams which may benefit from the processes of this invention include, but are not limited to, those set forth in Table 1.

TABLE 1

| | | | |
|---|---|---|---|
| Al₂O₃ | ZrO₂ Al₂O₃ Y₂O₃ | SiC | Al MgSi |
| Al₂O₃ SiO₂ | ZrO₂ MgO | ZrO₂ CaO | Al SiC Si |
| MgO Al₂O₃ SiO₂ | ZrO₂Y₂O₃ | SiO₂ Na₂O | Al Al₂O₃ |
| ZrO₂ Al₂O₃ SiO₂ | ZrO₂Y₂O₃ CaO | Al Si | Al SiC |
| Cordierite | zirconia | mullite | hydroxyl patitite |
| PZT | NZP | AlN | BN |
| B4C | HfC | TaC | ZrC |

Exemplary suppliers of open-cell carbon form include Koppers, Inc. of Pittsburgh, Pa. which makes “KFOAM”; Poco Graphite, Inc. of Decatur, Tex. which makes “POCOfoam” and “POCO HTC”; Touchstone Research Laboratory of Triadelphia, W. Va. which makes “CFOAM”; and GrafTech International Holdings of Parma, Ohio which make “GRAFOAM”. Other suppliers of open-cell ceramic foam (carbon and other ceramic foams) include Ultramet of Pacoima, Calif., ERG Materials and Aerospace Corporation of Oakland, Calif., SELEE Corproation of Hendersonville, N.C., Allied Foam Tech Corporation of Montgomeryville, Pa., Meiling Ceramic of P.R. China, and Foshan Ceramics Research Institute of P.R. China. The invention can be practiced with a variety of foam materials including carbon, graphite, silicon carbide, titania, aluminum oxide, zirconia, yittria, as well as other ceramic materials including oxides, carbides, borides, nitrides, silicides, and glasses.

In the practice of the invention, any metal forming a salt which can be dissolved into a solvent subsequently reduced upon the foam substrate can be employed for coating the open pores of the foam matrix. For example, ions of Cu²⁺ can generally be added as Cu salts such as CuSO₄, but halides, nitrates, acetates, and other organic and inorganic acid salts of Cu may also be used. Some examples of metals which can be used as salts (i.e., metal or metal alloy precursors) in a plating bath include Cu, Ni, Sn, Co, Ag, Au, Pt, Pd, Fe, Sb, As, Cd, In and Pb. Alloys of all the mentioned metals are also possible with the additional alloying elements of P, B, Re, Mo, W, Zn, as well as other elements. The solvents which can be used in the plating bath include any liquid capable of solvating the salt used as the metal source. Exemplary nonpolar solvents include hexane, benzene, toluene, diethyl ether, chloroform, and ethyl acetate. Polar aprotic solvents include 1,4-dioxane, tetrahydrofuran (THF), dichloromethane (DCM), acetone, acetonitrile (MeCN), dimethylformamide (DMF), and dimethyl sulfoxide (DMSO), Polar protic solvents include acetic acid, n-butanol, isopropanol (WA), n-propanol, ethanol, methanol, formic acid and water. Ionized solvents(molten salts) include chlorides, fluroides, nitrates, bromides, etc.

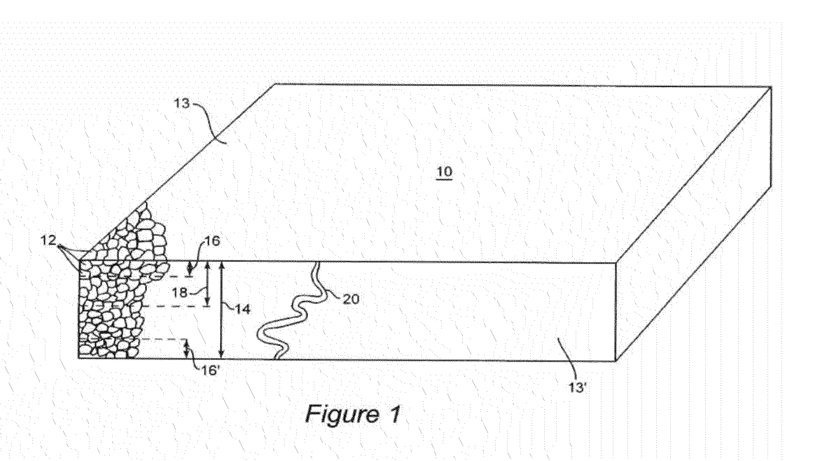

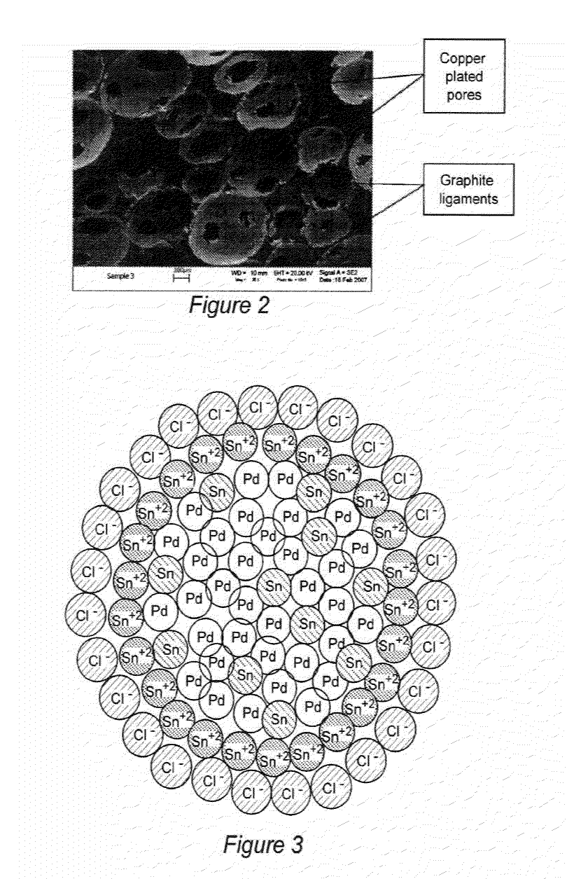

With reference to FIG. 1, it can be seen that the foam matrix 10 will have height, width, and thickness dimensions. The processes contemplated herein have particular application to foams with open pores 12 which range from 10 nanometers to 100 millimeters in diameter. The processes are particularly advantageous with foams having smaller pore sizes of 1 mm or less. The pores 12 do not need to be uniform in size; however, the foam matrix must have some open pores so that metal or metal alloy can coat the inside of the pores either deep into or throughout the width or thickness dimension 14 of the foam. For exemplary purposes, the open pores 12 are shown on a portion of the top surface 13 and side surface 13′; however, it should be understood that the foam matrix 10 will generally be constructed entirely from foam pores 12. Further, as will be discussed in more detail below, the foam matrix 10 can be part of a solid support or other device. In the practice of the invention, the plating bath solution will be driven into the foam matrix at least a distance 16 or 16′ of two pores 12 from a surface 13, and more preferably a distance 18 of five pores 12 or more from the surface 13. The invention thus allows coating more than, for example, the top surface 12 of the foam matrix. That is, the invention enables coating the pores of the open pore matrix deep into the thickness dimension and most preferably throughout its thickness dimension 14. The metal coating is conformal and does not plug the pores at the surface 13 of the foam matrix 10. Pathway 20 illustrates that the openings in the pores create a tortuous path from the top to the bottom of the foam matrix. Ideally, the invention will allow the entire pathway 20 to be coated with metal or metal alloy.

FIG. 2 shows a scanning electron microscopy image of copper plated pores in a graphite foam according to an example according to the invention. The pores are “open” as can be seen by the dark areas of the image, and the inside of the pores are coated with copper. Graphite ligaments are shown between the pores.

Using the procedures described herein a variety of foam matrices can have open pores coated with a variety of different metals and metal alloys including copper, nickel, aluminum, titanium, silver, gold, cobalt, tin, platinum, palladium, iron, antimony, arsenic, cadmium, indium, lead, neodymium, boron, phosphorous, samarium, bismuth, molybdenum, germanium, zinc, gallium, tungsten, vanadium, thallium, scandium, chromium, manganese, yttrium, zirconium, niobium, technetium, ruthenium, rhodium, hafnium, tantalum, rhenium, osmium, iridium, mercury and alloys containing any of these constituents such as:
Magnetic alloys including but not limited to: Permalloy, Alnico, Mu-metal, Fernico, Cunife, SmCo₅, Sm₂Co₁₇, Supermalloy, MKM steel,
Solder and brazing alloys including but not limited to: Sn/Pb, Sn/Pb70/30, Sn/Pb63/37, Sn/Pb60/40, Sn/Pb50/50, SnAgCu (SnAg_{3.5}Cu_{0.7}, Sn_{Ag3.5Cu0.9}, SnAg_{3.8}Cu_{0.7}, SnA_{g3.8}C_{u0.7}S_{b0.25}, SnAg_{3.9}Cu_{0.6}), SnCu_{0.7}, SnZn₉, SnZn₈Bi₃, SnSb₅, SnAg_{2.5}Cu_{0.8}Sb_{0.5}, SnIn_{8.0}Ag_{3.5}Bi_{0.5}, SnBi₅₇Ag₁, SnBi₅₈, SnIn₅₂, Ni/Ag, bronze, brass
   Structural and specialty alloys can also be plated onto foam matrices including but not limited to: Invar, Kovar, Nambé, Silumin, Megallium, Stellite, Ultimet, Vitallium, Electrum, Elinvar, amalgam, Inconel, Monel, Cromel, Hastelloy, Nichrom, Nitinol, Nisil, Cupronickel, Alnico, Zircaloy, and catalytic alloys

The process contemplated by the invention uses electrochemical metal deposition techniques. Electrochemical deposition of metals and alloys involves the reduction of metal ions from aqueous, organic, and fused-salt electrolytes. These techniques are known to those of skill in the art, and for the purpose of explanation herein the focus will remain on aqueous solutions only. The reduction of metal ions M^{z+} in aqueous solution is shown by Eq 1.

M^{z+}_{in solution}+ze⁻→M_{lattice} Eq 1

This can be accomplished via two different processes: (1) an electrodeposition process in which z electrons (e⁻) are provided by an external power supply or (2) an electroless deposition process in which a reducing agent in the solution is the electron source and there is no external power supply involved. These two processes, electrodeposition and electroless deposition, constitute electrochemical deposition and will be addressed in the following two sections.

Electrochemistry and electrode potential are well understood by those of skill in the art. For exemplary purposes, when a metal M is immersed in an aqueous solution containing ions of that metal, M^{z+} there will be an exchange of metal ions between the solution and the metal. Some M^{z+} ions from the crystal lattice enter the solution, and some ions from solution enter the crystal lattice. Initially one of these will occur faster than the other. Let us assume that conditions are such that more M^{z+} ions leave than enter the crystal lattice. In this case, there is an excess of electrons in the metal and it acquires a negative charge, q_{M}⁻ (charge on the metal per unit area). In response to the charging of the metal side of the interface, there is also a rearrangement of charges on the solution side. The negative charge on the metal attracts the positively charged M^{z+} ions from the solution and repels negatively charged ions. The result is an excess of positive M^{z+} ions in the solution in the vicinity of the metal/solution interface. At the same time, the solution side of the interface acquires opposite and equal charge, qₛ⁺ (the charge per unit area on the solution side of the interface). This positive charge on the solution side slows down the rate of M^{z+} ions leaving the crystal lattice (due to repulsion) and accelerates the rate of ions entering the crystal lattice. After a certain period of time a dynamic equilibrium between the metal M and its ions in the solution will result according to Eq 2,

M^{z+}+ze [symbol] M⁰ Eq 2

where z is the number of electrons involved in the reaction. In this reaction taken from left to right, electrons are consumed through the reduction of the metal ions. From right to left, electrons are released through the oxidation of M⁰. Again, equilibrium occurs when the rate at which both of these mechanisms occur is equal. When this is true, the charge on the metal (qₘ) is equal to the charge of the solution (−qₛ) at the interface.

Before and while this equilibrium is being reached, there exists a potential difference between that of the metal and the solution. In order to measure the potential difference of this interphase, it must be connected to another one forming an electrochemical cell. The potential difference can then be measured across the entire cell.

Electrochemical deposition takes advantage of the nonequilibrium transfer of ions to and from the solution. In the nonequilibrium state there is a steady state of ions either being deposited or dissolved from any electrode in contact with the electrolyte solution. During electroplating an external power source, commonly called a rectifier, is connected between two electrodes both of which are in contact with the electrolyte, and the applied voltage maintains a constant state of nonequilibrium causing constant deposition at the cathode. In electroless plating, the state of nonequilibrium is simply prolonged by complexing agents which bind metal ions allowing for controlled deposition of the plated species from a relatively concentrated electrolyte.

Electroless plating is also understood by those of skill in the art. For exemplary purposes, electroless (autocatalytic) plating involves the use of a chemical reducing agent to reduce chelated metal ions at the solution/substrate interface forming a uniform deposition upon the surface. This process can be done for several different metals and alloys including: Cu, Ni, Co, Pd, Pt, Au, Cr and a variety of alloys involving one or more of these constituents plus P or B. This process is deemed “electroless” due to the lack of a need for external electrodes or a power supply. There is however a transfer of electrons from the reducing agent to the metal ion according to Eq 3,

$${M}^{z +} + Red {{\to }_{surface}}^{catalytic} {M}^{0} + Ox \qquad Eq 3$$

where Ox is the oxidation product of the reducing agent, Red and M is the metal plated. According to mixed-potential theory, the overall reaction given by Eq 3 can be decomposed into one reduction (cathodic) reaction,

$${M}^{z +} + ze ( from reducing agent ) {{\to }_{surface}}^{catalytic} {M}^{0} \qquad Eq 4$$

and one oxidation (anodic) reaction.

$$Red {{\to }_{surface}}^{catalytic} Ox + ze \qquad Eq 5$$

These two partial reactions occur at one and the same electrode, the metal-solution interface. In order for electroless deposition to proceed, the equilibrium (rest) potential of the reducing agent must be more negative than that of the metal being plated.

However, Eq 5 can only occur only on a catalytic surface. Once the initial layer is deposited, the metallic layer itself acts as the catalytic surface, allowing for the process to continue. For most non-catalytic substrates, plating can be done, but only after some surface preparation rendering them catalytically active.

For deposition to occur, the metal must be reduced from solution. Controlled deposition can be promoted by the presences of a catalytic surface and generally leads to a more coherent coating. Various metals exhibit catalytic properties useful in chemical plating, including the precious metals Au, Ag, and members of the platinum metal family. Electroless plating can also occur on certain less noble metals such as Co, Ni, Cu and Fe, as well as conductive carbon, but these materials are not truly catalytic. Most useful electroless metal coating baths are autocatalytic, meaning the metal being deposited acts as a catalyst for further deposition, which allows the process to continue. The following are common methods to render a surface catalytic to electroless metal coating.

Exchange Plating—When attempting to plate a metal onto a less noble one, an exchange of charges occurs at the surface in which some of the more noble metal in solution is reduced as the less noble metal at the surface is oxidized and dissolved into the solution. This results in a layer of the more noble metal being deposited, which acts as the catalyst on which electroless plating then occurs.

Electroplated Deposited Seed Layer—If the base ceramic foam itself it conductive, catalytic material can be applied to the foam through traditional electroplating. Electroless plating can then initiate on the electroplated material, and subsequently self-propagate throughout the foam.

Sensitizing/Activation Catalysis—Sensitizing and activation (S/A) involve the application of a catalytic metal to a non-catalytic surface. As implied by the name, this involves two steps. The first step, sensitizing, consists of adsorbing a readily oxidized material onto the surface to be plated. Solutions containing tin(II) or titanium(III) salts and small amount of acid are commonly used. The addition of acid inhibits hydrolyzation of the metal salts, which leads to the formation of insoluble oxychlorides. In the case of Sn, the amount of Sn on the surface of the sensitized substrate is about 10 μg/cm³, and surface coverage is less than 25%. This Sn is in the form of dense clumps about 10-25 nm in size, consisting of particles on the order of 2.5 nm. Immersion in the sensitizing bath is normally done at 20°-30° C. for 1-3 min. Agitation can improve results, especially when plating complicated shapes. After this step, pieces must be thoroughly rinsed, as dragin of the sensitizer will destroy the activation bath. Avoid drying in air after this step, as the adsorbed Sn²⁺ can form SnO at the surface.

It is during the activation step that the surface truly becomes catalytic. The most effective activation solutions contain precious metal salts, such as gold, silver, or the platinum group metals (Au, Pt, Rh, Os, Ag), along with small additions of acid. Here, the acid stabilizes the bath by both limiting the precipitation of Pd particles and decreasing the reduction rate. Activation baths are used at 20-45° C., with immersion times of 1-2 min. When the sensitized piece comes in contact with the activation solution, the adsorbed sensitizer is readily oxidized, thereby reducing the activating metal and depositing it in the metallic state forming nucleation centers on the surface, according to the example in Eq. 6

Pd²⁺+Sn²⁺→Sn⁴⁺+Pd⁰ Eq 6

It is estimated that these catalytic nucleation centers are less than 1 nm in diameter, and their height is ˜4 nm. As an example, the amount of Pd on a glass substrate is generally 0.04-0.05 μg/cm³, which assuming uniform distribution corresponds to roughly 0.3 of a monolayer of Pd.⁴ The surface density of catalytic sites is substrate material dependent. For glass this is roughly 10¹⁴ sites/cm².

Thorough rinsing should also follow the activation step, as dragin of precious metal salts will cause spontaneous seeding and breakdown of most plating baths. An example S/A recipe can be found in Table 2.

TABLE 2
Example sensitizing and activation recipe

| Purpose | Constituents | notes | time, min | ° C. |
|---|---|---|---|---|
| Sensitizing | 120 ml DI water | stir and bring to temperature | 1-3 | 25-30 |
| | 3.0 g SnCl₂•2H₂O 98.2% | pour over powder and stir | | |
| | 5 ml HCl | do not allow undissolved | | |
| | | SnCl₂ to be transferred | | |
| | | DI rinse when done, 3x | | |
| | | Avoid drying | | |
| Activating | 125 ml DI water | stir and bring to temperature | 1-2 | 40-45 |
| | 0.03 g PdCl₂ 99.9+% | pour over powder and stir | | |
| | 0.063 ml HCl (~2 drops) | do not allow undissolved | | |
| | | PdCl₂ to be transferred | | |
| | | DI rinse when done, 3x | | |
| | | rinse once in ethyl-alcohol | | |
| | | allow to dry in air | | |

If, as sometimes is the case, a given metal can be reduced by the sensitizing ion, then it may not be necessary to utilize an activation bath. Instead, the substrate is immersed in the electroless bath immediately after sensitizing and rinsing. An example system, where this is the case, is electroless Cu or Ag when using a Sn(II) based sensitization bath.

### Colloidal Catalysis

This method is an alternative to sensitization and activation catalysis, utilizing a mixed colloidal catalyst. The colloid particles contain a core of reduced, metallic Pd, also containing a small amount of Sn metal. This core is surrounded by a stabilizing layer of Sn⁺² and Sn⁺⁴ ions, which attract dissolved chloride when in solution. Particle diameter can range from 2.5-35 nm, and is described by FIG. 2 (see particularly, Kanani, N. Electroplating and Electroless Plating of Copper & its Alloys, Finishing Publications, Ltd., Herts, UK, 2003.

Table 3 contains a recipe for a Sn/Pd colloid solution found by the author to catalyze a wide variety of plastic, ceramic and metallic substrates for electroless plating of Cu and Au. It is very stable and can be stored for long periods without deterioration.

TABLE 3
Recipe for a Sn/Pd colloidal catalyzing solution

| Purpose | Constituents | notes | Time, min | ° C. |
|---|---|---|---|---|
| Solution A | 1.4 g Na₂SnO₃•3H₂O | stir until all solids are | 15-20 | 15-20 |
| provides | 9.6 g SnCl₂•2H₂O 98.2% | dissolved | | |
| excess Sn ions | 40 ml HCl | | | |
| for stability | | | | |
| Solution B | 0.2 g PdCl₂ 99.9+% | combine PdCl2, HCL, and | See notes | 40-45 |
| formation of | 20 ml HC1 | water | | |
| colloid | 40 ml DI water | stir until all solids are | | |
| particles | 0.4 g SnCl₂•2H₂O 98.2% | dissolved (10-15 min) | | |
| | | add SnCl₂ and stir for 12 min, | | |
| | | the color will change from and | | |
| | | an initial dark green to dark | | |
| | | olive brown | | |
| Mixing | | pour solution B into A while | quickly | N/A |
| | | stirring | | |
| Activation | | cover | 50-65 | 180 |
| | | heat to 57° C. for 3 hrs | | |
| Dilution | | can be diluted down to 15 v % | | N/A |
| | | provided HCl makes up 10- | | |
| | | 20 v % of the final volume | | |

After mixing, the combination of solutions A and B is a concentrated solution containing roughly 58w % concentrated (37%) hydrochloric acid and 32w % water with the balance being Pd and Sn salts. It is immediately ready for use, but is made more aggressive by heating it to 50-65° C., for three hours.

An important variable in the preparation procedure, which affects the nature of the resulting colloid, is the length of time during which the stannous chloride is allowed to react with the palladium chloride in solution B, before it is combined with the balance of stannous chloride in solution A. This reaction time has a significant effect on the final particle size, size distribution and shape in the resulting colloid. Due to this, solution B must be stirred for approximately 12 min as times less than 10 minutes lead to marginal catalysis ability of the solution and times greater than 14 minutes lead to solution instability.

If the area to be plated requires high resolution as in the case of printed circuit boards, the prepared colloidal solution should be diluted 1:1 with DI water and with sufficient additional concentrated HCl to comprise 20-30v % of the final volume. For ordinary surface plating, the catalyzing solution should comprise 15v % prepared colloid, 10-20v % concentrated HCl, and the balance DI water.

Regardless of concentration, the substrate is immersed in or contacted with the activation solution for a minimum of 1 min at room temperature. Upon contact with the substrate, the colloidal particles adhere to the surface, forming catalytic nucleation sites. Following contact with the catalyzing solution, the substrate shall be thoroughly rinsed in DI water before immersion into a chemical plating bath. If the substrate is not to be immediately plated, it can be rinsed in alcohol, dried, and plated later.

After the catalytic solution is rinsed away, the ionic tin no longer plays a role, and can in fact bury the Pd core and detract from its catalytic activity. In some cases an acceleration step is required to remove the excess tin ions and expose the catalytic Pd surface. Some accelerating solutions include 1 M HCl, 1 M NaOH, 1 M NH4BF4, 1 M NH4HF2, 0.13 M EDTA at pH 11.7, and 0.13 M EDTA at pH 4.5. Substrates should be immersed for a minimum of 1 minute followed by thorough rinsing in DI water.

### Example 1

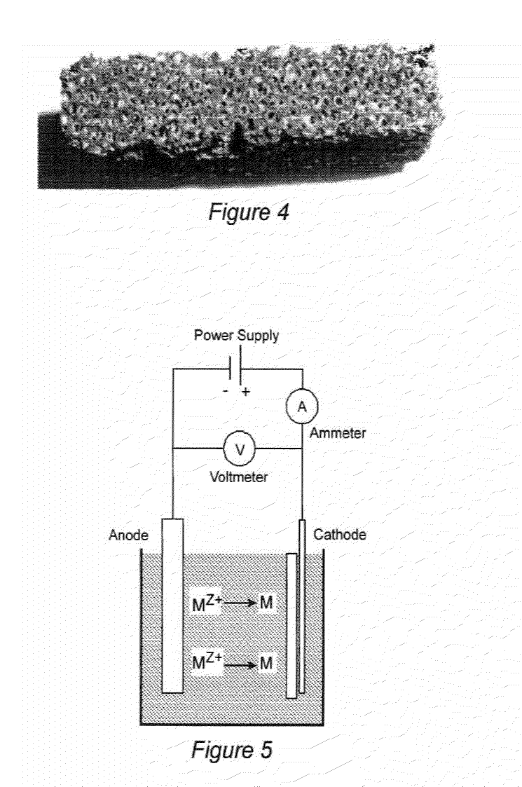

Most traditional methods used to coat carbon foams with metal have only been successful in coating only the most exposed outer surfaces of the material with nearly no penetration through the thickness. This invention will significantly improve the properties and performance of the foams in numerous applications as the properties of the deposited material are lent to the foam. Benefits from the improvement of this product can include increased strength, solderability, durability, toughness, corrosion resistance, thermal and electrical conductivity, catalytic behavior, etc. FIG. 4 shows a cross-sectional view of a copper coating throughout the thickness of a graphite foam.

Plating temperature can also greatly affect the film properties. Plating is typically done between 25 and 70° C. when plating copper. In general a fine-grained structure is produced at low temperatures, while as temperature is increased the grain structure becomes coarser and hydrogen adsorption is decreased, leading to improved ductility and increased electrical conductivity.

Electroless Plating of Copper—Typical electroless copper solutions comprise deionized water, a source of copper ions, a complexing agent for copper ions, a pH regulator, a reducing agent, and a bath stabilizing agent. Plating is usually performed between 30-80° C. Most commercial baths utilize formaldehyde (HCHO) under basic conditions as the reducing agent, thus only baths of this type will be addressed here. In this case, electroless Cu plating is a result of the reaction given in Eq. 7.

$${Cu}^{2 +} + 2 HCHO + 4 {OH}^{-} {{\to }_{surface}}^{catalytic} {Cu}^{0} + 2 {HCOO}^{-} + 2 {H}_{2} O + {H}_{2} \qquad Eq 7$$

Ions of Cu²⁺ are generally added as Cu salts, such as CuSO₄, but halides, nitrates, acetates and other organic and inorganic acid salts of Cu may be used. Since the solubility of Cu²⁺ decreases with increasing pH, complexing (chelating) agents are also commonly added to the plating bath to avoid the precipitation of copper(II)hydroxide (Cu(OH)₂). These ligands form coordinate bonds with the Cu²⁺ ions allowing them to stay in solution. Complexing agents are usually organic acids or their salts, such as EDTA, EDTP, and tartaric acid.

Basic conditions are generally realized through the addition of NaOH, elevating the pH to 12-13, where the plating rate reaches a maximum. Formic acid (HCOO⁻) is the oxidation product of the reducing agent, formaldehyde. Evolved H₂ gas and excess H₂O are formed as byproducts of the reaction, with Cu⁰ being left behind as a plated film on the catalytic surface.

Electrodeposition, the process used in electroplating and electroforming, is analogous to a galvanic or electrochemical cell acting in reverse. The part to be plated is the cathode of the circuit, while the anode generally provides ions of the metal to be plated. Both of these components are immersed into a solution containing one or more metal salts as well as other ions that permit the flow of electricity. A rectifier supplies a direct current to the cathode causing the metal ions in solution to lose their charge and plate out on the cathode. In most cases the electrical current flows through the circuit, the anode slowly dissolves and replenishes the ions in the bath, as seen in FIG. 5. Some electroplating processes use a noble, nonconsumable anode. In these situations, ions of the metal to be plated must be periodically replenished in the bath as the plate forms out of the solution.

Electrodeposition in the form of electroplating involves the coating of an electrically conductive object with a layer of metal using electrical current. Usually, the process is used to deposit an adherent surface layer of a metal having some desired property (e.g., abrasion and wear resistance, corrosion protection, lubricity, etc.) onto a substrate lacking that property. In the case of heavy plating, it is also used to build up thickness on undersized or worn parts. Metal anodes act as a source of electrons and in most cases are soluble and replenish the metal content of the electrolyte. Due to its metal ion content, the electrolyte is conductive and closes the electrical circuit which is fed by a source of low voltage direct current.

The following steps outline an exemplary procedure for electrolessly plating graphite foam with copper (it being understood that the order of steps could be changed and that some of the steps could simply be eliminated).
1. Thoroughly clean the sample
   Blow the foam with compressed air to free trapped particles
   Ultrasonically clean in an isopropyl alcohol bath
2. Prepare the bath solutions as seen in Tables 1 and 2*
3. Place foam in a preparation bath with a surfactant and water
   Surfactants may include: dish soap, an alcohol, etc.
   Use a syringe to push out the trapped air within the pores
   When the foam sinks, enough water has saturated the material
4. Place the foam in each of the baths as seen in Tables 4 and 5 and thoroughly rinse the sample with DI water between each solution
   Use a surfactant in each of the baths to reduce the surface tension of the fluids
   Continuously pump a syringe directly above the foam through each bath and rinsing solution
5. When the plating was completed, the sample was thoroughly rinsed with ethanol
   *The sensitizing and activating steps (Table 4) are not necessary to successfully plate graphite foam with copper, but those steps serve to promote adhesion and enhance the bond between the graphite and copper interface.

TABLE 4
Sensitizing and activating bath recipes

| Purpose | Constituents | notes | time, min | ° C. |
|---|---|---|---|---|
| Sensitizing | 120 ml DI water | stir and bring to temperature | 1-3 | 25-30 |
| | 3.0 g SnCl₂•2H₂O 98.2% | pour over powder and stir | | |
| | 5 ml HCl | do not allow undissolved | | |
| | | SnCl₂ to be transferred | | |
| | | DI rinse when done, 3x | | |
| | | Avoid drying | | |
| Activating | 125 ml DI water | stir and bring to temperature | 1-2 | 40-45 |
| | 0.03 g PdCl₂ 99.9+% | pour over powder and stir | | |
| | 0.063 ml HCl (~2 drops) | do not allow undissolved | | |
| | | PdCl₂ to be transferred | | |
| | | DI rinse when done, 3x | | |
| | | rinse once in ethyl-alcohol | | |
| | | allow to dry in air | | |

TABLE 5
Copper plating bath formulation

| Purpose | Constituents | notes | time, min | ° C. |
|---|---|---|---|---|
| Solution 1 | 30 ml DI water | stir until NaOH is dissolved | until | room |
| adjusts pH | 5.5 g NaOH | | dissolved | |
| Solution 2 | 80 ml DI water | stir vigorously | to temp | 50 |
| provides | 1.25 g CuSO₄•5H₂O | bring to temp | | |
| Cu ions | 98+% | add half of solution 1, bath | | |
| | 7.5 g EDTA 99.0-101.0% | color will change to light blue | | |
| | | and then change back to deep | | |
| | | blue | | |
| | | once all solids are dissolved, | | |
| | | add remainder of solution 1, | | |
| | | resulting pH should be ~12.5 | | |
| Solution 3 | 2.5 ml HCOH 37 w % in | slowly pour into | until | 50 |
| reduces | H₂O (10-15% methanol) | solution 2 | coated or | |
| Cu ions | | let stand 1 min | bath is | |
| | | add material to be plated | depleted | |

### Example 2

The following steps outline an exemplary procedure for electrolessly plating graphite foam with nickel (it being understood that the order of steps could be changed and that some of the steps could simply be eliminated).
1. Thoroughly clean the sample
   Blow the foam with compressed air to free trapped particles
   Ultrasonically clean in an isopropyl alcohol bath
2. Prepare the bath solutions as seen in Tables 6 and 7*
3. Place foam in a preparation bath with a surfactant and water
   Surfactants may include: dish soap, an alcohol, etc.
   Use a syringe to push out the trapped air within the pores
   When the foam sinks, enough water has saturated the material
4. Place the foam in each of the baths as seen in Tables 6 and 7 and thoroughly rinse the sample with DI water between each solution
   Use a surfactant in each of the baths to reduce the surface tension of the fluids
   Continuously pump a syringe directly above the foam through each bath and rinsing solution
5. When the plating was completed, the sample was thoroughly rinsed with ethanol
   *The sensitizing and activating steps (Table 6) are not necessary to successfully plate graphite foam with nickel, but those steps serve to promote adhesion and enhance the bond between the graphite and nickel interface.

TABLE 6
Sensitizing and activating bath recipes

| Purpose | Constituents | Notes | time, min | ° C. |
|---|---|---|---|---|
| Sensitizing | 120 ml DI water | stir and bring to temperature | 1-3 | 25-30 |
| | 3.0 g SnCl₂•2H₂O 98.2% | pour over powder and stir | | |
| | 5 ml HCl | do not allow undissolved | | |
| | | SnCl₂ to be transferred | | |
| | | DI rinse when done, 3x | | |
| | | Avoid drying | | |
| Activating | 125 ml DI water | stir and bring to temperature | 1-2 | 40-45 |
| | 0.03 g PdCl₂ 99.9+% | pour over powder and stir | | |
| | 0.063 ml HCl (~2 drops) | do not allow undissolved | | |
| | | PdCl₂ to be transferred | | |
| | | DI rinse when done, 3x | | |
| | | rinse once in ethyl-alcohol | | |
| | | allow to dry in air | | |

TABLE 7
Nickel plating bath formulation

| Purpose | Constituents | notes | time, min | ° C. |
|---|---|---|---|---|
| Solution 1 | 90 ml DI water | add NiSO₄ and Na₄P₂O₇ to DI | until | 70 |
| provides | 2.5 g NiSO₄•6H₂O | water | dissolved | |
| Ni ions | 5.0 g Na₄P₂O₇ | stir until dissolved | | |
| | 2.3 ml NH₄OH | slowly add NH₄OH, color will | | |
| | | change from lime to emerald | | |
| | | green | | |
| | | bring to temp | | |
| Solution 2 | 10 ml DI water | add NaH₂PO₂ to DI water | until | room |
| reducer | 2.5 g NaH₂PO₂ | stir until dissolved | dissolved | |
| | | add to solution 1 | | |
| | | let stand 1 min | | |
| | | add material to be plated | | |

### Example 3

The invention allows virtually any foam, and particularly open pore ceramic foams to be plated with metal and metal alloys, without plugging the surface of the foam, and in a way that allows the resulting foam-metal product to benefit from the attributes of both the foam matrix and the metal plating. A metallic coating would improve the solderability of the foams without closing the porosity, allowing air or fluids to continue to flow through the material. The products produced according to the above-described processes can be used in a number of different applications. Below is a non-exhaustive, exemplary listing of certain applications.

Thermal and Electrical Management

Several existing technologies to aid in the dissipation of heat exist, but none offer the surface area of foams without further machining. In heat dissipation applications materials must have high thermal conductivities, be able to withstand high temperatures, have a low coefficient of thermal expansion (CTE), and have mechanical stability. The combination of graphite foam with a copper coating is an ideal solution. Graphite is a highly thermally conductive ceramic and copper is second only to silver in its thermal conductivity amongst metals. The foam structure gives a high surface area to dissipate heat without the added cost of machining. The copper coating increases the fracture toughness of the overall composite, while the graphite keeps the strength from deteriorating at high temperatures. Graphite foam has already been shown to have a low CTE, and adding the copper will not change that; it will however keep the copper from flaking off at high temperatures.

To use a ceramic as a heat sink requires bonding it to the device that is creating the heat. The addition of the copper onto the carbon makes this a trivial process of soldering the foam onto the necessary substrate. Such applications could take the form of heat sinks, heat exchangers, phase-change cooling systems, and thermally conducting structures. It would have applications on jet engines, satellite thermal panels, avionics enclosures, and computer chips.

EMI Shielding:

Another use of the copper coated graphite foam would be for use as electromagnetic interference shielding. EMI shielding is dependent on mesh size and thickness of the conducting material. The carbon foams have pore sizes in the area of half a millimeter, which would be sufficient to block out microwaves and radio waves.

Catalysis:

The speed of catalysis and ionization is limited by the available surface area that comes in contact with the requisite molecules. Foams, which consist of a large surface area to volume ratio, are well suited to catalyzing chemical reactions. Platinum and nickel are very common catalysts and are already used in devices such as catalytic converters. Nickel is also used as a catalyst for hydrogenation in the pharmaceutical, food, and petrochemical industries.

Nickel and Platinum are common catalyst materials. Fuel cells can use these to assist in the ionization of the hydrogen. It would be beneficial to use a plated graphite foam for two reasons. Firstly, the foam structure would give a large surface area of the catalyst that could be used for the ionization process. Secondly, the noble catalyst and carbon are both acid resistant. Fuel cells are very acidic (negative pH levels), and it is necessary to have a structure that can withstand such an environment. If a crack were to form in the catalyst coating, the graphite would still be able to function both mechanically and as a conductor of electrons so the fuel cell would continue to function.

Ferromagnetic Coatings

The ability to plate the foam with nickel or complex ferromagnetic alloys such as “Permalloy”, could lend ferromagnetic properties. By placing a foam coated with such a material in an alternating magnetic field, it is possible to heat the foam though induction. This effect could be used to efficiently heat liquids.

Acoustic Dampening and Mechanical Strength:

Titanium is a very versatile material offering a few possibilities when plated onto a carbon foam. Titanium is even more chemically inert than nickel. It is chemically inert to dilute sulfuric and hydrochloric acid, most organic acids, most chlorine gas, and chloride solutions. Titanium also has the highest strength-to-weight ratio of any metal.

Titanium is chemically inert nature makes it ideal for use in the human body. Titanium coated carbon foams would be better than solid titanium for the use of bone repair and replacement because it would use less titanium than a solid piece (thus reducing cost) and would allow bone to grow throughout the porosity allowing the bone to more easily and sufficiently heal itself. Titanium coated foams would also be used, due to their superior acoustic dampening ability, for the manufacture of gun silencers.

While the invention has been described in terms of its preferred embodiments, those of skill in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A ceramic matrix foam having open pores of sizes ranging from 10 nanometers to 100 millimeters with a coating of metal or metal alloy adhered inside said open pores, wherein said ceramic matrix foam has a thickness dimension greater than five times an average diameter of said open pores, and wherein said coating of metal or metal alloy extends from a surface of said ceramic matrix foam a distance of two or more pores in said thickness dimension.

2. The ceramic matrix foam of claim 1 wherein said ceramic matrix foam is selected from the group consisting of carbon, graphite, silicon carbide, titania, alumina, mullite, cordierite, zirconia, yittria, and ceramic oxides, carbides, borides, nitrides, silicides and glasses.

3. The ceramic matrix foam of claim 1 wherein said coating of metal or metal alloy is selected from the group consisting of copper, nickel, aluminum, titanium, silver, gold, cobalt, tin, platinum, palladium, iron, antimony, arsenic, cadmium, indium, lead, neodymium, boron phosphorous, samarium, bismuth, molybdenum, germanium, zinc, gallium, tungsten, vanadium, thallium, scandium, chromium, manganese, yttrium, zirconium, niobium, technetium, ruthenium, rhodium, hafnium, tantalum, rhenium, osmium, iridium, mercury, and alloys containing any of these constituents.

4. The ceramic matrix foam of claim 1 wherein said thickness dimension is greater than ten times an average diameter of said open pores, and wherein said coating extends a distance of five or more pores in said thickness dimension.

5. The ceramic matrix foam of claim 1 wherein said open pores have a diameter of 1 mm or smaller.

6. A method of producing a foam matrix having open pores coated with a metal or metal alloy, comprising the steps of:
providing or forming a plating bath composition containing precursors for metal or metal alloys, said plating bath containing at least one constituent which reduces a surface tension of said plating bath composition by at least 25% compared to said plating bath composition without said at least one constituent; and
exposing a foam matrix having open pores of sizes ranging from 10 nanometers to 100 millimeters to said plating bath composition such that a metal or metal alloy coating is formed inside said open pores a distance of two more pores in a thickness dimension from a surface of said foam matrix.

7. The method of claim 6 wherein said at least one constituent is a surfactant.

8. The method of claim 6 wherein said preparing step reduces said surface tension by at least 15 dynes/cm.

9. The method of claim 6 wherein said preparing step includes the step of heating said plating bath composition.

10. The method of claim 6 wherein said exposing step includes the step of applying pressure to said plating bath composition after said plating bath composition contacts said surface of said foam matrix.

11. The method of claim 6 further comprising the step of pretreating said foam matrix prior to said exposing step so as to promote adhesion of said metal or metal alloy coating to said open pores of said foam matrix.

12. The method of claim 6 wherein said providing or forming step is performed simultaneously with said exposing step by said at least one constituent being present on said foam and said exposing step combines said foam with said plating bath.

13. The method of claim 6 wherein said providing or forming step includes associating said at least one constituent with a fixture used during a plating process.

14. A method of producing a foam matrix having open pores coated with a metal or metal alloy, comprising the steps of:
providing or forming a plating bath composition containing precursors for metal or metal alloys, said plating bath having a surface tension of 50 dyn/cm or less; and
exposing a foam matrix having open pores of sizes ranging from 10 nanometers to 100 millimeters to said plating bath composition such that a metal or metal alloy coating is formed inside said open pores a distance of two more pores in a thickness dimension from a surface of said foam matrix.

15. The method of claim 14 wherein said plating bath composition has a surface tension of 40 dyn/cm or less.

16. The method of claim 14 preparing step includes the step of heating said plating bath composition.

17. The method of claim 14 wherein said exposing step includes the step of applying pressure to said plating bath composition after said plating bath composition contacts said surface of said foam matrix.

18. A method of producing a foam matrix having open pores coated with a metal or metal alloy, comprising the steps of:
preparing a plating bath composition containing precursors for metal or metal alloys;
heating said plating bath composition to a temperature that is less than a boiling point of a base solvent of said plating bath composition; and then
exposing a foam matrix having open pores of sizes ranging from 10 nanometers to 100 millimeters to said plating bath composition such that a metal or metal alloy coating is formed inside said open pores a distance of two more pores in a thickness dimension from a surface of said foam matrix.

19. A method of producing a foam matrix having open pores coated with a metal or metal alloy, comprising the steps of:
preparing a plating bath composition containing precursors for metal or metal alloys;
exposing a foam matrix having open pores of sizes ranging from 10 nanometers to 100 millimeters to said plating bath composition; and
applying a pressure to said plating bath composition after contact with a surface of said foam matrix such that said plating bath composition is driven into said foam matrix without crushing said foam matrix and a metal or metal alloy coating is formed inside said open pores a distance of two more pores in a thickness dimension from said surface of said foam matrix.

20. The method of claim 19 wherein said foam matrix is a ceramic material, and wherein said pores have a size of 1 mm or less.
